(19) United States
(12) Patent Application Publication
(10) Pub. No.: US 2007/0281857 A1
(43) Pub. Date: Dec. 6, 2007

(54) FORMIC ACID AS AN HERBICIDE

(75) Inventors: Charles L. Wilson, Shepherdstown, WV (US); Pamela G. Marrone, Davis, CA (US); Lorena Fernandez, Davis, CA (US); Marja Koivunen, Davis, CA (US); Brian Campbell, Davis, CA (US)

Correspondence Address: CHERYL H AGRIS PHD, PO BOX 806, PELHAM, NY, 10803, US

(73) Assignee: MARRONE ORGANIC INNOVATIONS, Davis, CA (US)

(21) Appl. No.: 11/756,212

(22) Filed: May 31, 2007

Related U.S. Application Data
(60) Provisional application No. 60/803,777, filed on Jun. 2, 2006.

(51) Int. Cl. A01N 25/00

(52) U.S. Cl. 504/116.1

(57) ABSTRACT

The present invention discloses that, formic acid or salt thereof, is an effective pre-emergent and post-emergent herbicide. Formic acid biodegrades to carbon dioxide and water thus posing not threat the environment. With proper formulation and the use of respiratory protection, formic acid also poses no threat to the applicator. Formic acid is demonstrated in this invention to control both monocotyledonous and dicotyledonous plants.

### PRIORITY CLAIM

This application claims priority under 35 U.S.C. §119(e) to provisional application no. filed Jun. 2, 2006, the contents of which are incorporated herein by reference.

### FIELD OF THE INVENTION

This invention relates to compositions and methods for controlling weeds using compounds comprising formic acid or salt thereof as an active ingredient.

### BACKGROUND OF TIE INVENTION

Weeds cause up to 12% loss in crop yields in the United States each year costing nearly $33 billion dollars (Pimentel et al., 2001). Farmers have to rely mainly on synthetic herbicides to reduce these losses and spend $6.1 billion dollars each year to control weeds. In 1998, herbicides accounted for 68% of total U.S. pesticide sales. Many herbicidal products contain glyophosate (see, for example, U.S. Pat. No. 6,200,929).

There are two general categories of herbicides: pre-emergence and post-emergence. Organic growers have discovered that corn gluten meal (a by-product in the manufacture of cornstarch) can serve as an effective pre-emergence herbicide. Since corn gluten meal affects only sprouting seeds, it is safe to use around mature or established plants. Herbicidal “soaps” serve as organic post-emergence herbicides. These products contain fatty acid salts that break down into carbon dioxide and water. A commercially available fatty acid (pelargonic acid) is sold under the trade name Scythe™.

Researchers have reported on the herbicidal capabilities of various combinations of fatty acids with synthetic herbicides to control weeds. Caulder, J. et al. [U.S. Pat. No. 5,196,049] disclose fatty acids or mixtures of fatty acids combined with one or more synthetic herbicides to achieve synergistic control of a broad array of weeds. A series of Japanese patents also report herbicidal combinations of fatty acids with synthetic herbicides [JP1106501; JP59199609; JP59193804]. Additionally, U.S. 2004/0266852 discloses agricultural compositions, particularly for fungicidal use, comprising one or more fatty acids and one or more organic acids.

Natural oils have been used since the beginning of this century as herbicides and oils are commonly added to synthetic herbicides to enhance their efficacy. Dudai et al. (1999) found that when essential plant oils extracted from Origanum syriacum, Micromeria fructicona, and Cymbopogon citrates were mixed with soil they inhibited germination of wheat and Amaranthus seeds. Recently, Tworkoski explored the herbicidal effects of essential oils of plants as herbicides (2002). He found that essential oils (1% v/v) from red thyme, summer savory, cinnamon, and clove were the most phytotoxic (herbicidal) among the twenty five essential oils tested. Essential oil of cinnamon had high herbicidal activity and eugenol (2-methoxy-4-(2-propenyl)phenol.) was determined to be its major component (84%).

Acetic acid has been used as a broad-spectrum organic herbicide. It is available commercially under the trade names “Nature's Glory Weed and Grass Killer” (25% acetic acid) manufactured by Monterey Lawn and Garden Products and “BurnOut” Weed and Grass Killer (25% acetic acid) manufactured by St. Gabriel Laboratories. The USDA found that acetic acid was effective against 80% of the annual weeds tested including foxtail, lambsquarters, and pigweed. While acetic acid may burn off the tops of Canada thistle and other perennials it does not control the root system responsible for plant regeneration.

Formic acid, also known as methanoic or formylic acid, is a natural compound that is found in insects, cheese, peaches, and other foods. It is known to be produced in nature by ants as a protectant against predators (Frederickson et al., 2005, Frederickson et al., 2007, “Short New”, Medecine Sciences 2005, volume 21, number 12, page 1038). Formic acid (CAS #64-18-6) is a colorless liquid compound used in the manufacture of a wide variety of products including fumigants, animal feed additives, and commercial paint strippers. Its largest use is as a silage additive in Europe. Formic acid is also used in textile dyeing and finishing, leather tanning, nickel plating baths, electroplating, coagulating rubber, and dehairing and plumping hides. It is used as a solvent for perfumes and in the manufacture of lacquers, glass, vinyl plasticizers, and fomate esters for flavor and fragrance. It has been disclosed that formic acid can boost the pesticidal or herbicidal effect of synthetic pesticidal/herbical compounds (see, for example, PCT patent application publication no. WO01/33961, US Patent Application Publication Nos. US2004/0048747 and US2006/0247130 and U.S. Pat. Nos. 6,200,929 and 6,831,038.

Formic acid is registered by EPA as a pesticide (Mite-Away II™, MiteGone™) for the control of tracheal mites and in the suppression of varroa mites in honey bee hives (see U.S. Pat. No. 6,837,770). It is formulated as a gel, and is contained in a vented plastic pouch that allows slow release of formic acid vapors. Formic acid is used in these instances as a natural alternative to hazardous organophosphates currently used in the U.S. for these purposes.

### SUMMARY OF THE INVENTION

The present invention discloses the use of formic acid as a pre-emergent and post-emergent herbicide, particularly the use of formic acid for the preparation of a composition for herbicidal use, either as a pre-emergent or post-emergent pesticide. In a particular embodiment, formic acid is used as a pre-emergent pesticide and is applied to the soil. It can serve as a safer alternative to synthetic herbicides now on the market. Thus, the invention is directed to a method for modulating emergence of monocotyledonous or dicotyledonous weeds comprising applying to said weeds in soil an amount of formic acid effective to modulate emergence of monocotyledonous or dicotyledonous weeds in soil. Alternatively, the invention is directed to a method for modulating emergence of monocotyledonous or dicotyledonous weeds in soil comprising applying to said soil an amount of formic acid effective to modulate emergence of monocotyledonous or dicotyledonous weeds in said soil.

Furthermore, the invention is directed to a composition comprising formic acid and/or one or more formic acid salts present in an herbicidally effective amount and a carrier and/or diluent, which is essentially free of fatty acid present in an herbicidally effective amount as well as a method for modulating emergence of monocotyledonous or dicotyledonous weeds in soil comprising applying to said weeds and/or said soil an amount of said composition effective to modulate emergence of monocotyledonous or dicotyledonous weeds in soil. In a particular embodiment, the invention is directed to a polyphenol-free, glyphosate-free herbicidal composition comprising (a) formic acid and/or one or more formic acid salts and (b) a carrier and/or diluent, wherein said composition is free of fatty acid and free of an amine containing surfactant in an herbicidally effective amount as well as a method for modulating emergence of monocotyledonous or dicotyledonous weeds in soil comprising applying to said weeds and/or said soil an amount of said composition effective to modulate emergence of monocotyledonous or dicotyledonous weeds in soil. In a preferred embodiment, the composition is in solid form, particularly in the form of a solid granule.

In a particular embodiment, the composition comprises (a) formic acid and/or (b) one or more formic acid salts, (c) one or more essential oils and (d) carrier and/or diluent, as well as a method for modulating emergence of monocotyledonous or dicotyledonous weeds in soil comprising applying to said weeds in soil an amount of said composition effective to modulate emergence of said weeds in said soil. Alternatively, the method for modulating emergence of monocotyledonous or dicotyledonous weeds may comprise applying first the formic acid or its salt to said weeds and/or said solil and then applying one or more essential oils or vice versa or alternatively concurrently.

In the method of the present invention, compositions applied to the soil are used as pre-emergent herbicides and may be in solid form. In a particular embodiment, they may be dissolved in a diluent.

### OBJECTS OF THE INVENTION

A primary object of the invention is to provide pre- and post-emergence herbicidal compositions and in particular solid pre-emergent herbicidal compositions that contain formic acid as an active ingredient.

Another object is to provide a safe, non-toxic herbicidal composition and a method that will not harm the environment.

It is a further object of the present invention to provide a novel herbicide that is comprised of food grade materials and is exempt from US Environmental Protection Agency (EPA) registration.

It is still another object to provide an herbicidal composition to which plants can not develop resistance.

The above and other objects are accomplished by the present invention which is directed to herbicidal compositions containing formic acid with certain carriers to control germination of weed seeds in soil and other growth media. In addition, the present innovation is directed to a method for post-emergence control of broadleaved and grass weeds using an herbicidal composition containing formic acid as an active ingredient.

### BRIEF DESCRIPTION OF THE FIGURES

FIG. 1 shows inhibition of seed germination using organic acids in monocot seeds.

FIG. 2 shows inhibition of seed germination using organic acids in dicot seeds.

### DETAILED DESCRIPTION OF THE INVENTION

Where a range of values is provided, it is understood that each intervening value, to the tenth of the unit of the lower limit unless the context clearly dictates otherwise, between the upper and lower limit of that range and any other stated or intervening value in that stated range is encompassed within the invention. The upper and lower limits of these smaller ranges may independently be included in the smaller ranges is also encompassed within the invention, subject to any specifically excluded limit in the stated range. Where the stated range includes one or both of the limits, ranges excluding either both of those included limits are also included in the invention.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, the preferred methods and materials are now described.

It must be noted that as used herein and in the appended claims, the singular forms “a,” “and” and “the” include plural references unless the context clearly dictates otherwise.

The present invention discloses the use of formic acid as a pre- and post-emergence herbicide. It can serve as a safer alternative to synthetic herbicides now on the market.

In one embodiment, the present invention provides an herbicidal composition comprising, in admixture with a suitable carrier and optionally with a suitable surface active ingredient, formic acid or formic acid salt at concentrations between 0.001-95% by weight. The formic acid salt may be an organic alkali metal salt selected from the group consisting of sodium and potassium. The composition of the present invention may comprise formic acid and/or one or more formic acid salts. In a particular embodiment, the formic acid salt is a monoformate alkali metal salt, in particular, sodium monoformate or potassium monoformate.

The compositions of the present invention may be sprayed on the plant or applied to the soil. Particular embodiments are described in the Examples, infra. These compositions may be in the form of dust, coarse dust, micro granules, granules, wettable powder, emulsifiable concentrate, liquid preparation, suspension concentrate, water degradable granules or oil suspension. In a specific embodiment, the compositions are in solid form in the form of a granule.

The compositions of the invention do comprise a carrier an/or diluent. The term, ‘carrier’ as used herein means an inert, organic or inorganic material, with which the active ingredient is mixed or formulated to facilitate its application to the soil, seed, plant or other object to be treated, or its storage, transport and/or handling. The carrier used will depend on whether it is being used in a pre- or post-emergence herbicide. Liquid carriers can be used for both pre and post-emergence applications. Examples of carrier vehicles for the pre-emergence herbicide include, but are not limited to, active charcoal, corn gluten meal, soybean meal, vermiculite, bentonite, kaolinite, wheat germ, almond hulls, cottonseed meal, Fuller's earth, orange pulp, rice hulls, sawdust, Gum arabic, etc. If desired, plant essential oils such as cinnamon, clove, thyme (eugenol as active ingredient), wintergreen, citronella and pine oil, and the like, can be included in the granules to improve the pre-emergence and post-emergence effect of formic acid. Examples of diluents or carriers for the post-emergence herbicides include, but are not limited to, water, milk, ethanol, mineral oil, glycerol, and other organic acids such as acetic, propionic and citric acid.

The composition may additionally comprise a surfactant to be used for the purpose of emulsification, dispersion, wetting, spreading, integration, disintegration control, stabilization of active ingredients, improvement of fluidity or rust inhibition. The choice of dispersing and emulsifying agents, such as non-ionic, anionic, amphoteric and cationic dispersing and emulsifying agents, and the amount employed is determined by the nature of the composition and the ability of the agent to facilitate the dispersion of the herbicidal compositions of the present invention. In a particular embodiment, the composition is free of an amine containing surfactant.

For pre-emergence dry formulations, the granule size of the carrier is typically 1-2 mm (diameter) but the granules can be either smaller or larger depending on the required ground coverage. Granules may comprise of porous or non-porous particles, and they generally contain 0.05-25%, preferably 5-15% formic acid and/or formic acid salt.

For post-emergent formulations, the formulation components used may contain smectite clays, attapulgite clays and similar swelling clays, thickeners such as xanthan gums, gum Arabic and other polysaccharide thickeners as well as dispersion stabilizers such as nonionic surfactants (for example polyoxyethylene (20) monolaurate). The concentration of the clays may vary between 0-2.5% w/w of the total formulation, the polysaccharide thickeners may range between 0-0.5% w/w of the total formulation and the surfactants may range between 0-5% w/w of the total formulation.

In commercial and agricultural applications, the present invention encompasses carrier composition mixture in which the herbicidal compositions are present in an amount between about 0.01-95% by weight, and preferably 0.5-90% by weight, of the mixture.

The composition and method of the present invention will be further illustrated in the following, non-limiting Examples. The examples are illustrative of various embodiments only and do not limit the claimed invention regarding the materials, conditions, weight ratios, process parameters and the like recited herein.

### EXAMPLES

### Example 1

Numerous natural compounds were screened for their ability to inhibit the germination of seeds. A single seed was placed in each well of a 96-well plate followed by a solution of each compound in water at both 0.5% and 0.1%. Germination was monitored at varying intervals, depending on the germination time in the control groups for the particular seed being used in the study. The ability of formic acid to inhibit germination of seeds was recognized and verified in both dicots (radishes) and monocots (wheat).

### Example 2

Numerous natural compounds were screened for their ability to inhibit the germination of dicot seeds. A single seed of Lactuca sativa (lettuce) was placed in each well of a 96-well plate followed by a solution of each compound in a stepwise dilution series from 25% to 0%. Germination was monitored daily. Based on this screening study, the threshold value for formic acid to inhibit germination of seeds was determined at 0.0013%.

### Example 3

A high-throughput 96-well assay was used to test the efficacy of formic acid as a post-emergence, non-selective herbicide. Seedlings of Lactuca sativa (lettuce) were grown in 96-well plates under continuous light. Formic acid was added on the seedlings at a 5x-dilution series from 20% to 0%, and the minimum concentration needed for killing the seedling was recorded the next day. According to the results, formic acid at a concentration of 0.8% was able to kill the lettuce seedling, whereas formic acid at a concentration of 0.16% was not harmful for the plant.

### Example 4

Procedure:

To further test the inhibitory effect of formic acid on germinating seeds, pots with 6-cm diameter were filled with 60 mL of silty clay loam soil passed through a 2-mm sieve, and five (5) seeds of either Taraxacum officinale (dandelion, representing a broadleaved weed) or Poa annua (annual bluegrass, representing a grass weed) were planted on the top. A solid form of the composition containing corn gluten meal granules (1-2 mm diameter) soaked in 0%, 5%, 10% or 20% formic acid solution and dried were placed on the top of the soil at rates 0.1, 0.25, 0.5 and 1.0 g/pot. The pots were kept at optimum water content under growth lights with a 12-h light/dark period at room temperature, and the number of germinated seeds was counted after one week. The results were reported as a percent of weed seeds germinated relative to the control treatment with no corn gluten meal added. The results are presented in Table 1 below.

TABLE 1

| | | |
|---|---|---|
| Formic | rate | germination rate (%) |

| acid % | g/pot | dandelion | annual bluegrass |
|---|---|---|---|
| 0 | 0.1 | 50 | 27 |
| | 0.25 | 50 | 54 |
| | 0.5 | 0 | 82 |
| | 1 | 0 | 82 |
| 5 | 0.1 | 100 | 100 |
| | 0.25 | 50 | 82 |
| | 0.5 | 0 | 82 |
| | 1 | 0 | 82 |
| 10 | 0.1 | 0 | 100 |
| | 0.25 | 0 | 100 |
| | 0.5 | 0 | 54 |
| | 1 | 100 | 54 |
| 20 | 0.1 | 0 | 100 |
| | 0.25 | 0 | 54 |
| | 0.5 | 0 | 27 |
| | 1 | 0 | 0 |

Conclusion: A product made by imbedding 20% formic acid in small corn gluten meal granules at a rate 1.0 g/pot (corresponding to ) inhibited the germination of both the broadleaved and grass weed used in this study.

### Example 5

Pots with 3-cm diameter were filled with 60 mL of silt clay loam soil passed through a 2-mm sieve, and five (5) seeds of either Taraxacum officinale (dandelion, representing a broadleaved weed) or Poa annua (annual bluegrass, representing a grass weed) were planted on the top. A solid form of the composition containing corn gluten meal granules (>2 mm diameter) soaked in 0%, 10%, 15% or 20% formic acid solution and dried were placed on the top of the soil at rates 0.1, 0.25, 0.5 and 1.0 g/pot. The pots were kept at optimum water content under growth lights with a 12-h light/dark period at room temperature, and the number of germinated seeds was counted after one week. The results were reported as a percent of weed seeds germinated compared with the control treatment with no corn gluten meal added. The results are presented in Table 2 below.

TABLE 2

| | | |
|---|---|---|
| Formic | rate | germination rate (%) |

| acid % | g/pot | dandelion | annual bluegrass |
|---|---|---|---|
| 0 | 0.1 | 30 | 100 |
| | 0.25 | 30 | 100 |
| | 0.5 | 0 | 30 |
| | 1 | 0 | 100 |
| 10 | 0.1 | 60 | 100 |
| | 0.25 | 30 | 100 |
| | 0.5 | 30 | 30 |
| | 1 | 0 | 100 |
| 15 | 0.1 | 30 | 0 |
| | 0.25 | 30 | 0 |
| | 0.5 | 30 | 0 |
| | 1 | 0 | 100 |
| 20 | 0.1 | 0 | 100 |
| | 0.25 | 0 | 100 |
| | 0.5 | 0 | 100 |
| | 1 | 0 | 100 |

Conclusion: With the bigger granules, complete control of a broadleaved weed was achieved using a product imbedded in 15% formic acid. However, this was not effective for the control of the grass seed germination. Formic acid embedded in corn gluten meal seems to be more effective for the control of broadleaved than grass weeds, which might make it suitable for selective control of broadleaved weeds in grass (lawn and turf).

### Example 6

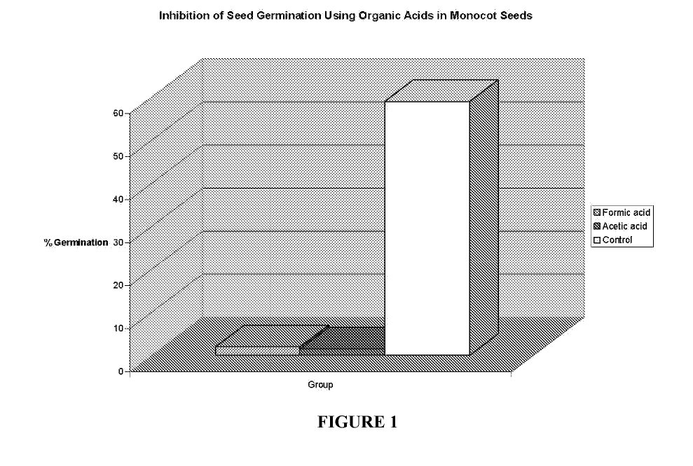

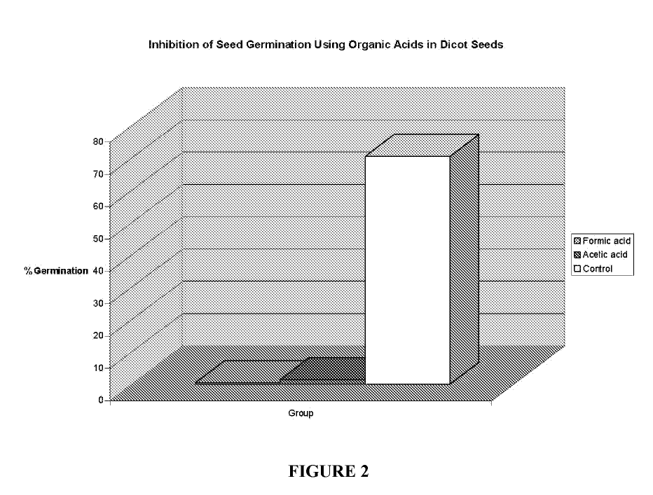

In order to test whether or not this observation would hold when applied to soil containing seeds, charcoal was saturated with formic acid at a rate of 1 mL acid/1 g charcoal, as well as with both water, as a control, and with acetic acid, as a comparison with another acid known to have herbicidal effects. Charcoal was applied to soil in flats containing a known number of seeds, either monocot or dicot, and germination was monitored in each of the treatment groups following intervals determined by the rate of germination in controls. The results of this experiment are shown in FIGS. 1 and 2. The experiment revealed that formic acid has a profound effect on the germination of both monocot and dicot seeds, the magnitude of which is equivalent to that of acetic acid.

### Example 7

To test different carriers for formic acid, corn starch (powder), clay (granular, >2 mm diameter) and sand (small grain) were saturated with formic acid solutions (1, 3, and 5%) and dried at room temperature. Dry product (7.5 mL) was mixed with 60 mL of either potting mix or soil, and the mixture was placed in a small pot. Five (5) seeds of Lactuca sativa (lettuce) were planted on the top of each pot, and the seeds were covered with sand. The pots were incubated at room temperature under continuous light for 7 days, after which the number of seeds germinated in each pot was recorded and presented as a germination rate relative to the untreated control.

TABLE 3

| Formic | germination rate | | | | | |
|---|---|---|---|---|---|---|
| acid | potting mix | | | soil (silty clay loam) | | |
| % | corn starch | clay | sand | corn starch | clay | sand |
| 1 | 100 | 100 | 100 | 100 | 100 | 100 |
| 3 | 100 | 80 | 80 | 75 | 100 | 100 |
| 5 | 100 | 60 | 20 | 100 | 50 | 100 |

Out of all tested products, 5% formic acid imbedded in clay granules gave the best control of germination of lettuce used as a representative of dicot plants.

### Example 8

In order to estimate the length of time during which the presence of formic acid in the soil would have a negative effect on new, and perhaps desirable, plantings, a residue study was performed. Holes were cut into the bottoms of flats. The flats were then filled with soil and treated with charcoal immersed in either formic acid or water, just as described above. Soil was watered regularly in order to simulate natural growing conditions and soil leaching. Ten apple seedlings were planted in individual flats containing one treatment or the other at intervals of one week and survival was monitored for one week following each planting. At week 1, 100 percent of planted seedlings survived in the flats treated with water, while only 80 percent survived in those treated with formic acid. By week 1, however, and in all subsequent weeks, survival in the formic acid group and the water group was identical at 100 percent. This would indicate a residual herbicidal effect lasting less than one week.

### Example 9

The herbicidal effect of formic acid was compared with that of acetic acid in a greenhouse study using radish (Raphanus sativus) and wheat (Triticum aestivum) as test plants. Both formic acid and acetic acid were diluted in water at 1, 3, and 5%, and deionized water was used as a control. Tween 20 was added to each of the solutions at a rate 0.04% for use as a surfactant. Solutions were applied to plants using a small handheld sprayer. Plants were evaluated at 24- and 72-hours after treatment for the % control.

Formic acid gave 100% control of all radish plants at both 24-h and 72-h time points. This was comparable to acetic acid at 5% dilution. Acetic acid at 1 and 3% was able to control 51 and 71% of the dicot weeds, respectively. The efficacy of formic acid was lower on wheat (monocot); even the highest concentration of formic acid (5%) was able to control only 1 and 4% of wheat seedlings at time points 24-h and 72-h, respectively. Acetic acid was more potent in controlling grass weeds like wheat; after 72-h, acetic acid at 5% controlled 28% of wheat seedlings, and the lower concentrations (1 and 3%) resulted in 5-14% control. It appears that Formic acid is more effective than acetic acid in controlling broadleaved weeds, but less effective on grass weeds.

### Example 10

In order to determine whether formic acid could be used as a foliar herbicide it was applied as a foliar spray to the leaves of dicotyledonous radish plants (Raphanus sativas) and monocotyledonous wheat plants (Triticum aestivum). Solutions were applied to plants using a small handheld sprayer.

Formic acid and acetic acid solutions at three concentrations (1%, 3%, 5%) were applied and water was used as a check. A barrier was inserted between the rows of plants on either side of the row being treated to avoid drift of sprays into neighboring rows. Plants were evaluated at 24-hour and 72-hour intervals for the number of surviving plants and a percentage was derived from this number in comparison with the number of plants originally present in the row.

After one day post-treatment, formic acid completely killed all the foliage of the dicotyledonous radish plants at all concentrations (1%, 3%, 5%), whereas, acetic acid killed all foliage at 5% concentration with 30% and 50% of the foliage surviving at the 3% and 1% concentrations, respectively.

After one day post-treatment, formic acid was ineffective in killing the foliage of the monocotyledonous wheat plants with only 10% of the plants being killed at the highest concentration of 5% and none of the foliage killed at 1%. This is in comparison with acetic acid that killed 30% of the plants at a 5% concentration. It was noted during the application of the solutions to the wheat seedlings that adherence to leaves was poor with wheat, presumably because of its grass-like structure, which caused the treatments to run off of the leaves quickly.

Although this invention has been described with reference to specific embodiments, the details thereof are not to be construed as limiting, as it is obvious that one can use various equivalents, changes and modifications and still be within the scope of the present invention.

Various references are cited throughout this specification, each of which is incorporated herein by reference in its entirety.

### REFERENCES

Dudai, N., Poljakoff-Mayber, A., Mayer, A. M., Putievsky, E., Lerner, H. R. 1999. Essential oils as allelochemicals and their potential use as bioherbicides. Journal of Chemical Ecology 25: 1079-1089.
Frederickson et al. 2005. ‘Devil's gardens’ bedeviled by ants. Nature 437:495.
Frederickson et al., 2007, The devil to pay: a cost of mutualism with Myrmelachista schumanni ants in ‘devil's gardens’ is increased herbivory on Duroia hirsuta trees Proc. R. Soc. B 274:1117-1123.
“Short News”, Medecine Sciences 2005, volume 21, number 12, page 1038.
Pimentel, D., McNair, S., Janecka, J., Wightman, J., Simmonds, C., O'Connell, C., Wong, E., Russel, L., Zern, J., Aquino, T., Tsomondo, T. 2001. Economic and environmental threats of alien plant, animal, and microbe invations. Agriculture Ecosystems & Environment 84: 1-20.
Tworkoski, T. 2002. Herbicide effects of essential oils. Weed Science 50: 425-431.

What is claimed is:

1. A polyphenol-free, glyphosate-free herbicidal composition comprising formic acid and/or one or more formic acid salts and a carrier and/or diluent, wherein said composition is free of fatty acid in an herbicidally effective amount and a non-amine containing surfactant.

2. The composition according to claim 1, wherein said composition comprises formic acid.

3. The composition comprising claim 1, wherein said composition comprises formic acid in an herbicidally effective amount.

4. The composition according to claim 1, wherein said composition comprises a formic acid salt.

5. The composition according to claim 4, wherein said formic acid salt is an alkaline metal salt.

6. The composition according to claim 4, wherein said composition is a formic acid salt is a monoformate salt.

7. The composition according to claim 4, wherein said formic acid salt is an alkaline metal salt selected from the group consisting of potassium and sodium.

8. The composition according to claim 1 wherein said composition comprises a formic acid salt in an herbicidally effective amount.

9. The composition according to claim 1 wherein said composition further comprises an essential oil.

10. The composition according to claim 1, wherein said composition is in solid form.

11. The composition according to claim 10, wherein said composition is in solid form and is soluble in a diluent.

12. An herbicidal composition comprising formic acid present in an herbicidally effective amount and a carrier and/or diluent, wherein said composition is free of fatty acid in an herbicidally effective amount.

13. An herbicidal composition comprising (a) formic acid and/or one or more formic acid salts, (b) one or more essential oils and (c) a carrier and/or diluent.

14. The composition according to claim 13, wherein said essential oil is selected from the group consisting of cinnamon, clove, thyme, wintergreen, citronella and pine oil.

15. A method for modulating emergence of monocotyledonous or dicotyledonous weeds in soil comprising applying to said weeds and/or said soil an amount of formic acid and/or one or more formic acid salts effective to modulate emergence of monocotyledonous or dicotyledonous weeds in soil.

16. The method according to claim 13, wherein said formic acid is applied to soil.

17. A method for modulating emergence of monocotyledonous or dicotyledonous weeds in soil comprising applying to said weeds and/or soil comprising an amount of the composition of claim 1 effective to modulate emergence of said monocotyledonous or dicotyledonous weeds in soil.

18. A method for modulating emergence of monocotyledonous or dicotyledonous weeds in soil comprising applying to said weeds and/or soil an amount of the composition of claim 10 effective to modulate emergence of said monocotyledonous or dicotyledonous weeds in soil.

19. A method for modulating emergence of monocotyledonous or dicotyledonous weeds in soil comprising applying to said weeds and/or soil an amount of the composition of claim 11 effective to modulate emergence of said monocotyledonous or dicotyledonous weeds in soil.

20. A method for modulating emergence of monocotyledonous or dicotyledonous weeds in soil comprising applying to said weeds and/or soil formic acid or salt thereof and nonessential oil are present in amounts effective to modulate emergence of said monocotyledonous or dicotyledonous weeds.
